(19) United States
(12) Patent Application Publication
(10) Pub. No.: US 2017/0136564 A1
(43) Pub. Date: May 18, 2017

(54) Multi-sectional Drilling and Tapping Apparatus

(71) Applicant: Shajeng Hardware Co., Ltd., Taichung City (TW)

(72) Inventor: Jen-Tsung Liao, Taichung City (TW)

(21) Appl. No.: 14/979,438

(22) Filed: Dec. 27, 2015

Related U.S. Application Data
(63) Continuation-in-part of application No. 14/944,270, filed on Nov. 18, 2015, now abandoned.

(51) Int. Cl. B23G 5/20; B23G 5/06

(52) U.S. Cl. CPC B23G 5/20; B23G 5/06; B23G 2200/143; B23G 2200/34; B23G 2200/48; B23G 2200/46

(57) ABSTRACT

A multi-sectional drilling and tapping apparatus includes a shank, a drill and a tap that are made in one piece. The shank is formed at an end while the drill is formed at another end. The drill includes a small section formed between a tip and a large section. The drill further includes helical blades extending to the shank from the tip. The tap includes helical ribs each extending from a corresponding one of the helical blades and groups of tooth-shaped blades each evenly arranged along a corresponding one of the helical ribs. The tap includes a diameter larger than that of the large section of the drill.

### BACKGROUND OF INVENTION

1. Field of Invention

The present invention relates to drills and taps, more particularly, to a multi-sectional drilling and tapping apparatus.

2. Related Prior Art

In a conventional drilling and tapping process, a drill is used to make a hole in a work-piece before a tap is used to make a helical groove in the wall of the hole, thus leaving a thread on the wall of the hole and turning the hole into a screw hole. In the process, two cutters are used, i.e., the drill and the tap. A machine is used to drive the drill and the tap, one after another. The machine has to be shut down to replace the drill with the tap. Hence, it takes a long period of time to complete the process, i.e., the efficiency of the process is low. The tap might not be perfectly co-axial with the drill, thus resulting in a poor quality of the screw hole.

To solve the above-discussed problems, a drill can be combined with a tap. With such combination, the drilling and tapping process becomes continuous and efficient process since the machine does not have to be stopped to replace the drill with the tap, and the quality of the screw hole is good since the tap is coaxial with the drill.

Taiwanese Patent M419631 discloses a coaxial drilling and tapping apparatus that includes a tap connected to an end of a drill. With such conventional coaxial drilling and tapping apparatus, it is possible to complete drilling and tapping in a continuous process. However, the use of such conventional coaxial drilling and tapping apparatus is not without any problems.

Firstly, the drill is connected to the tap by engagement of threads with each other. The use of the threads inevitably renders the connection of the drill to the tap tighter when the coaxial drilling and tapping apparatus is driven in a direction. Hence, the coaxial drilling and tapping apparatus can be used to make a screw hole. However, the use of the threads inevitably renders the connection of the drill to the tap slacker when the coaxial drilling and tapping apparatus is driven in an opposite direction. Hence, the drill might be detached from the tap and left in the screw hole in an attempt to remove the coaxial drilling and tapping apparatus from the screw hole.

Secondly, the drill includes only two helical blades. Hence, the drill contacts the wall of the hole at two points. Such two-point contact is inadequate to keep the tapping perfectly coaxial with the drilling.

Thirdly, the drill includes a constant diameter and strong resistance is encountered from the beginning of the drilling if the co-axial drilling and tapping apparatus is used to make a large screw hole since the resistance gets stronger as the diameter of the drill gets larger. To overcome such strong resistance, it takes a lot of energy to drive the co-axial drilling and tapping apparatus, and the drill could soon be worn out.

The present invention is therefore intended to obviate or at least alleviate the problems encountered in prior art.

### SUMMARY OF INVENTION

It is the primary objective of the present invention to provide an effective, efficient and durable drilling and tapping apparatus.

To achieve the foregoing objective, the drilling and tapping apparatus includes a shank, a drill and a tap that are made in one piece. The shank is formed at an end while the drill is formed at another end. The drill includes a small section formed between a tip and a large section. The drill further includes helical blades extending to the shank from the tip. The tap includes helical ribs each extending from a corresponding one of the helical blades and groups of tooth-shaped blades each evenly arranged along a corresponding one of the helical ribs. The tap includes a diameter larger than that of the large section of the drill.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a multi-sectional drilling and tapping apparatus according to the preferred embodiment of the present invention;

FIG. 2 is an exploded view of the multi-sectional drilling and tapping apparatus shown in FIG. 1;

FIG. 3 is a cross-sectional view of a work-piece processed with the multi-sectional drilling and tapping apparatus shown in FIG. 1;

FIG. 4 is another cross-sectional view of the work-piece and the multi-sectional drilling and tapping apparatus shown in FIG. 3; and

FIG. 5 is an enlarged partial view of the work-piece and the multi-sectional drilling and tapping apparatus shown in FIG. 3.

### DETAILED DESCRIPTION OF PREFERRED EMBODIMENT

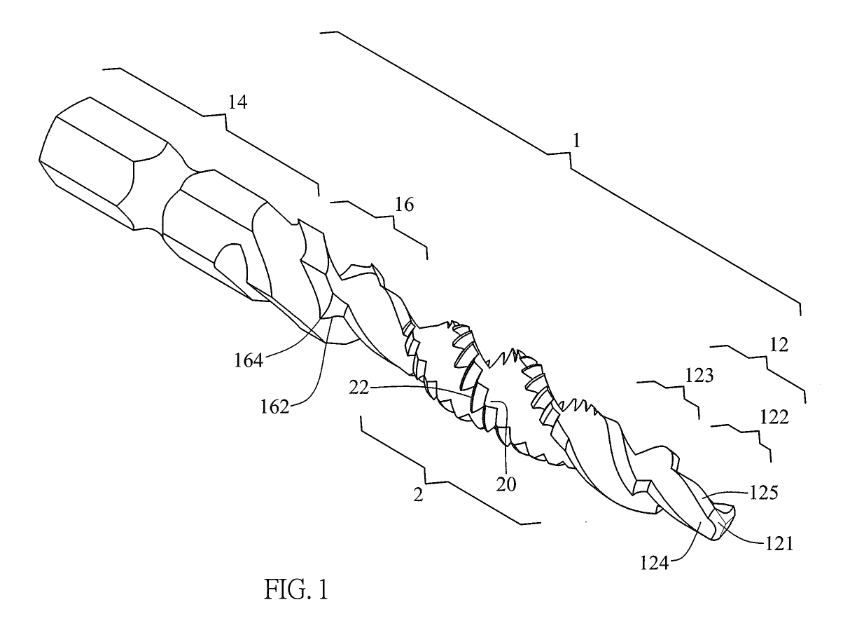

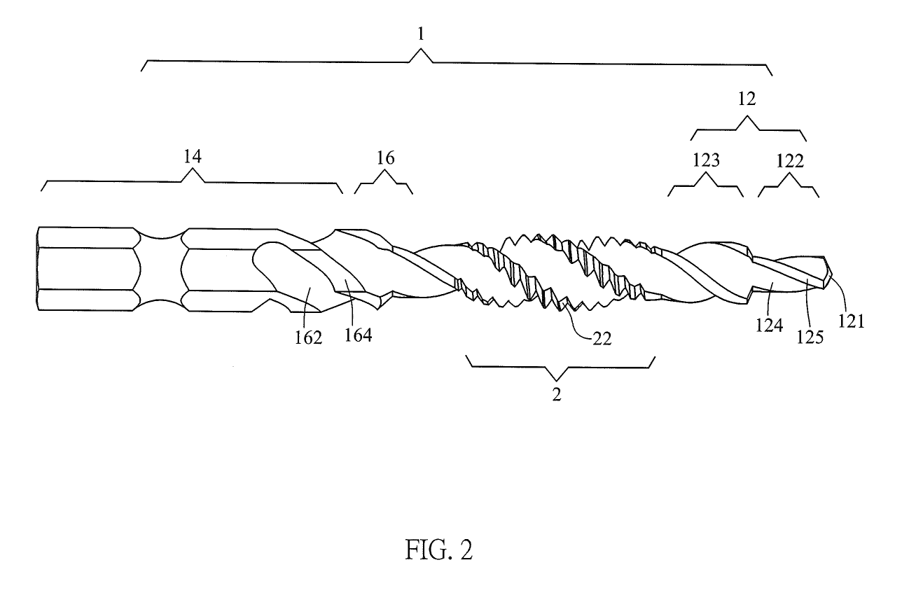

Referring to FIGS. 1 and 2, a multi-sectional drilling and tapping apparatus 1 includes a drill 12, a tap 2, a bore 16 and a shank 14 that are made in one piece according to the preferred embodiment of the present invention. The drill 12 is formed at an end of the multi-sectional drilling and tapping apparatus 1 while the shank 14 is formed at another end of the multi-sectional drilling and tapping apparatus 1. The tap 2 is formed next to the drill 12. The bore 16 is formed next to the shank 14.

The drill 12 includes a tip 121, a small section 122, a large section 123, three helical grooves 124 and three helical blades 125. The tip 121, the small section 122, and the large section 123 are sequentially arranged, with the tip 121 located furthest from the shank 14. The diameter of the small section 122 is smaller than that of the large section 123. Each of the helical grooves 124 extends to the large section 123 from the tip 121 via the small section 122, and so does each of the helical blades 125. The helical grooves 124 and the helical blades 125 are alternately arranged. The drill 12 preferably includes three helical grooves 124 and three helical blades 125 located from one another by an angle of 120°.

The profile of the shank 14 is marginally larger than that of the large section 123 of the drill 12. The profile of the shank 14 can be circular or polygonal. The diameter of the shank 14 is marginally larger than that of the large section 123 of the drill 12 where the profile of the shank 14 is circular.

The bore 16 includes three helical grooves 162 and three helical blades 164. Each of the helical grooves 162 is an extension from a corresponding one of the helical grooves 124. Each of the helical blades 164 is an extension from a corresponding one of the helical blades 125. Hence, the helical grooves 162 and the helical blades 164 are alternately arranged. Each of the helical blades 164 gets higher as it extends to the shank 14 from the drill 12. That is, the diameter of the bore 16 gets larger as the bore 16 extends to the shank 14 from the drill 12.

The tap 2 includes three helical ribs 20 and three groups of tooth-shaped blades 22. Each of the helical ribs 20 is an extension of a corresponding one of the helical blades 125. Each of the groups of tooth-shaped blades 22 is arranged along a corresponding one of the helical ribs 20. The diameter of the tap 2 gets larger as the tap 2 extends to the bore 16 from the drill 12. That is, the diameter of the tap 2 is smaller than the bore 16 but larger than that of the drill 12. The height of each of the tooth-shaped blades 22 measured from the corresponding helical rib 20 gets smaller as the tooth-shaped blade 22 extends towards two ends from a middle portion.

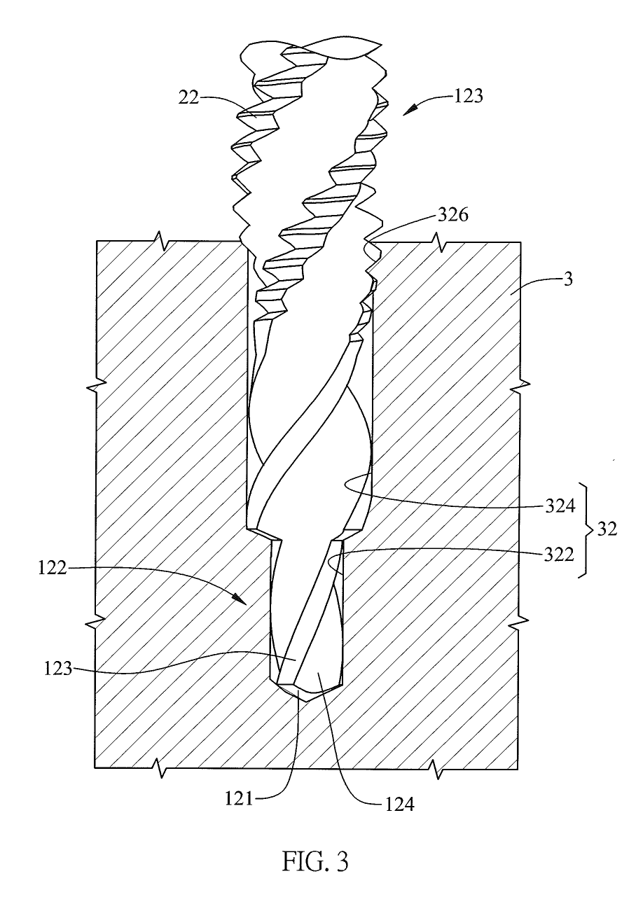

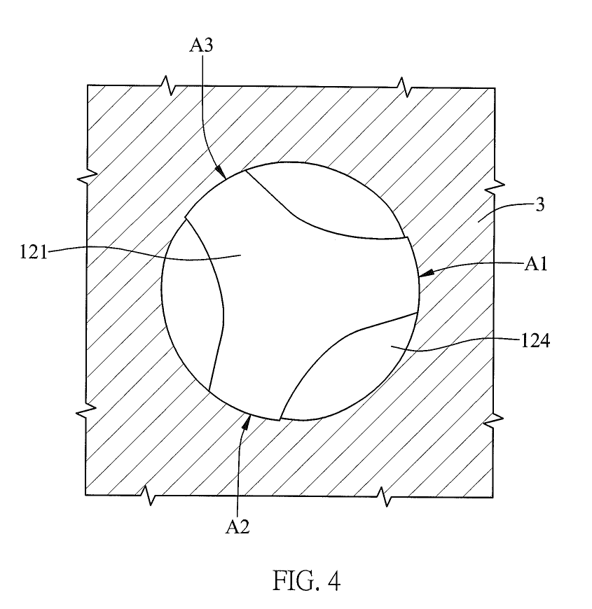

Referring to FIGS. 3 and 4, a drilling and tapping apparatus 1 made with a tap 2 corresponding to a desired screw hole in a work-piece 3 is selected. The tip 121 of the drill 12 is placed on the surface of the work-piece 3 before the tip 121 of the drill 12 is used to drill a hole 32 in the work-piece 3. Then, the helical blades 125 in the small section 122 of the drill 12 are used to drill the hole 32 deeper and larger in the work-piece 3, i.e., making a small section 322 of the hole 32. Then, the helical blades 125 in the large section 122 of the drill 12 are used to drill the hole deeper and larger in the work-piece 3, i.e., making a large section 324 of the hole 32. As the large section 123 of the drill 12 is in the large section 324 of the hole 32, the tooth-shaped blades 22 of the tap 2 make a thread 326 on the hole 32 by cutting a helical groove in the wall of the hole 32 as the large section 123 of the drill 12 turns the small section 322 of the hole 32 into the large section 324 of the hole 32.

Only weak resistance is encountered in the use of the blades 125 in the small section 122 of the drill 12 to make the small section 322 of the hole 32 since the diameter of the small section 122 of the drill 12 is small. This weak resistance is good for the stability and precision of the use of the helical blades 125 in the large section 123 of the drill 12 to make the large section 324 of the hole 32.

Weak resistance is encountered in the use of the blades 125 in the large section 123 of the drill 12 to make the large section 324 of the screw hole 32 since the small section 322 of the screw hole 32 has already been made. Therefore, the stability and precision of the use of the helical blades 125 in the large section 123 of the drill 12 to make the large section 324 of the screw hole 32 are high.

In the tapping, the small section 122 of the drill 12 guides the large section 123 of the drill 12 to drill without encountering strong resistance. Since the drill 12 includes three helical blades 125, the drill 12 contacts the wall of the hole 32, including the small section 322 and the large 324, at three points A1, A2 and A3. Thus, the axis of the tap 2 is kept aligned with the axis of the desired hole 32, including the small section 322 and the large section 324. Hence, the depth of the helical groove in the wall of the hole 32 is constant, and so is the height of the thread 326.

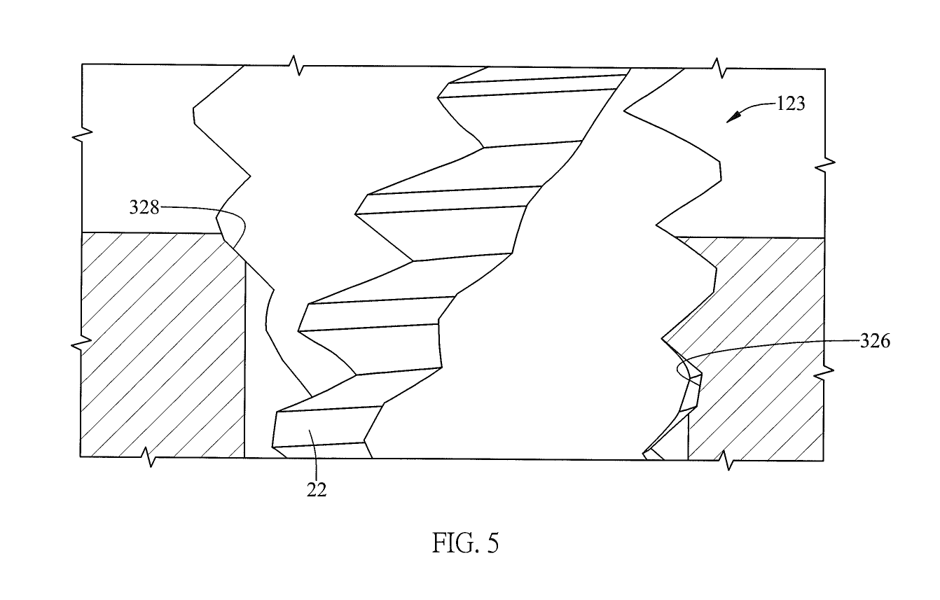

Referring to FIG. 5, the drilling and tapping apparatus 1 goes deeper in the hole 32 to bring the bore 16 to an open end 328 of the hole 32. The helical blades 164 of the bore 16 enlarge the open end 328 of the hole 32, thus turning the hole 32 into a countersink hole. The enlarged open end 328 of the hole 32 can receive a head of a screw or threaded bolt (not shown) inserted in the hole 32.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A drilling and tapping apparatus comprising:
a shank formed at an end;
a drill formed at another end and made with a tip, a large section, a small section formed between the tip and the large section and helical blades extending to the shank from the tip; and
a tap comprising helical ribs each extending from a corresponding one of the helical blades and groups of tooth-shaped blades formed on the helical ribs, wherein each of the groups is evenly arranged along a corresponding one of the helical ribs, wherein the tap comprises a diameter larger than that of the large section of the drill, wherein the shank, the drill and the tap are made in one piece.

2. The drilling and tapping apparatus according to claim 1, further comprising a bore formed between the shank and the tap, wherein the bore comprises helical blades each extending from a corresponding one of the helical ribs, wherein the bore comprises a diameter that gets larger as it extends to the shank from the tap.

3. The drilling and tapping apparatus according to claim 1, wherein the drill comprises three helical blades.

4. The drilling and tapping apparatus according to claim 3, further comprising a bore formed between the shank and the tap, wherein the bore comprises helical blades each extending from a corresponding one of the helical ribs, wherein the bore comprises a diameter that gets larger as it extends to the shank from the tap.

5. The drilling and tapping apparatus according to claim 3, wherein the shank comprises a profile larger than that of the drill.

6. The drilling and tapping apparatus according to claim 5, further comprising a bore formed between the shank and the tap, wherein the bore comprises helical blades each extending from a corresponding one of the helical ribs, wherein the bore comprises a diameter that gets larger as it extends to the shank from the tap.

7. The drilling and tapping apparatus according to claim 5, wherein the profile of the shank is selected from the group consisting of a circle and a polygon.

8. The drilling and tapping apparatus according to claim 7, further comprising a bore formed between the shank and the tap, wherein the bore comprises helical blades each extending from a corresponding one of the helical ribs, wherein the bore comprises a diameter that gets larger as it extends to the shank from the tap.

9. A drilling and tapping apparatus comprising:
a shank formed at an end;
a drill formed at another end and made with a tip, a large section, a small section formed between the tip and the large section, and three helical blades extending to the shank from the tip; and
a tap comprising three helical ribs each extending from a corresponding one of the helical blades and three groups of tooth-shaped blades formed on the helical ribs, wherein each of the groups is evenly arranged along a corresponding one of the helical ribs, wherein the tap comprises a diameter larger than that of the large section of the drill, wherein the shank, the drill and the tap are made in one piece.

10. The drilling and tapping apparatus according to claim 9, further comprising a bore formed between the shank and the tap, wherein the bore comprises helical blades each extending from a corresponding one of the helical ribs, wherein the bore comprises a diameter that gets larger as it extends to the shank from the tap.

11. The drilling and tapping apparatus according to claim 9, wherein the shank comprises a profile larger than that of the drill.

12. The drilling and tapping apparatus according to claim 11, further comprising a bore formed between the shank and the tap, wherein the bore comprises helical blades each extending from a corresponding one of the helical ribs, wherein the bore comprises a diameter that gets larger as it extends to the shank from the tap.

13. The drilling and tapping apparatus according to claim 11, wherein the profile of the shank is selected from the group consisting of a circle and a polygon.

14. The drilling and tapping apparatus according to claim 13, further comprising a bore formed between the shank and the tap, wherein the bore comprises helical blades each extending from a corresponding one of the helical ribs, wherein the bore comprises a diameter that gets larger as it extends to the shank from the tap.
